(19) United States
(12) Patent Application Publication
(10) Pub. No.: US 2016/0322670 A1
(43) Pub. Date: Nov. 3, 2016

(54) HIGH-EFFICIENCY, HIGH-TEMPERATURE, SODIUM-BASED ELECTROCHEMICAL CELL

(71) Applicant: FIAMM ENERGY STORAGE SOLUTIONS S.P.A., Montecchio Maggiore(VI) (IT)

(72) Inventors: Silvio RESTELLO, Montecchio Maggiore (VI) (IT); Nicola ZANON, Montecchio Maggiore (VI) (IT); Zeno RESIDORI, Montecchio Maggiore (VI) (IT); Giorgio CRUGNOLA, Montecchio Maggiore (VI) (IT); Giuseppe LODI, Montecchio Maggiore (VI) (IT)

(73) Assignee: Fiamm Energy Storage Solutions S.P.A., Montechio Maggiore (VI) (IT)

(21) Appl. No.: 15/105,275

(22) PCT Filed: Dec. 19, 2014
(86) PCT No.: PCT/EP2014/003447

§ 371 Date: Jun. 16, 2016

(30) Foreign Application Priority Data
Dec. 20, 2013 (IT) MI2013A002155

(51) Int. Cl. H01M 10/39; H01M 4/66; H01M 10/659; H01M 10/64; H01M 10/654

(52) U.S. Cl. CPC H01M 10/399; H01M 10/64; H01M 10/654; H01M 10/659; H01M 4/661; H01M 4/662; H01M 2300/0068

(57) ABSTRACT

A high-efficiency, high-temperature, sodium-based electrochemical cell comprises an outer steel casing (12) coated with nickel, elongated parallelepiped in shape, a ceramic electrolyte (14) in the shape of a tubular body made of β-alumina inserted in said outer casing, a plurality of capillary profiles consisting of shaped sheets (16), arranged between said outer casing (12) and ceramic electrolyte (14) with respect to which they leave an interspace, and a current collector (18) of metal material coaxially inserted and stabilised in the ceramic electrolyte (14). Said current collector is formed by a tubular body defining a cavity at least partially filled with PCM (phase change materials) material.

### CROSS REFERENCE TO RELATED APPLICATIONS

This application is a national phase of PCT application No. PCT/EP2014/003447, filed Dec. 19, 2014, which claims priority to IT patent application No. MI2013A002155, filed Dec. 20, 2013, all of which are incorporated herein by reference thereto.

### FIELD OF INVENTION

The present invention relates to a high-efficiency, high-temperature, sodium-based electrochemical cell.

More particularly, the present invention relates to an electrochemical cell as defined above, integrating means which limit the temperature increase thereof in that they favour both the absorption of heat generated during the discharge steps and the reduction of the dispersion of the heat itself to the outside.

### BACKGROUND OF THE INVENTION

There are, as is known, so-called secondary electrochemical cells that, for the construction of batteries, use sodium (Na) as the anode and a ceramic electrolyte such as beta-alumina ( [symbol] ″A [symbol] 2θ3); this substance has on the one hand a good conductivity to the passage of sodium ions (Na<+>) and, on the other hand, it also carries out a function of separator between the anode and cathode, being provided with high resistivity to the flow of electrons.

A high-temperature, sodium-based electrolytic cell, for example of the sodium-nickel chloride (Na—NiCb) type, comprises a plurality of components that can be identified as follows:

an outer casing, typically of elongated parallelepiped shape, made of nickel-plated steel;

a ceramic electrolyte tubular in shape, made of β″-alumina;

a cover that closes the upper end of the ceramic electrolyte, for example made of alpha-alumina (a-alumina);

a plurality of capillary profiles in the shape of shaped sheets, arranged between the outer casing and the ceramic electrolyte,

extending by the entire useful ion exchange length and forming an interspace between said outer casing and ceramic electrolyte;

a current collector consisting of a metal rod bent on itself, developed in the ceramic tube forming the electrolyte and connected at the ends by a metal ring;

a second electrolyte in liquid form or “catholyte”, consisting of sodium tetrachloroaluminate (IMaAICU);

the active material consisting of sodium chloride (NaCI) granules and nickel powder and/or other powders of transition metals.

The positive pole is formed by the current collector, while the negative one is formed by the outer casing of the cell. The latter is hermetically sealed, with the electrodes insulated from each other and from the external environment, while the sealing on the ceramic tube is given by the a-alumina cover.

The electrochemical cells of this type are used to make batteries that are used in various fields, including those of backup power in telecommunications and in the electric power of road vehicles. In said batteries, which typically consist of several tens of elementary cells, the operating temperature is usually in the range between 260° C. and 270° C. but can increase significantly during a discharge at high current rates. The traditional cooling systems designated for this purpose are based on forced circulation of air in special radiators by means of fans, which disperse heat without any possibility to recover it; such systems, in addition, reduce the temperature unevenly, since not all cells are impinged by the cooling flow in the same way and with the same intensity. This results, within the cell pack, in strong thermal imbalances which are detrimental to the health of the battery, affecting the life thereof. In addition to these drawbacks, in the known subject electrochemical cells the distance between the current collector inserted centrally in the tubular ceramic electrolyte and the inner side surface of the same ceramic electrolyte is not constant, since the first one consists of a rod bent on itself while the second is generally shaped with a circular section or a substantially cloverleaf section. Due to the variable distance between the mentioned components, the ion exchange does not take place in an optimal way as it would be desirable, to the detriment of the overall efficiency of the cell.

### SUMMARY OF THE DISCLOSURE

The object of the present invention is to overcome the drawbacks mentioned above.

More particularly, the object of the present invention is to provide a high-efficiency, high-temperature, sodium-based electrochemical cell which allows keeping the temperature inside the pack cells as constant as possible, avoiding dangerous thermal imbalances.

A further object of the invention is to provide a high-efficiency cell which also allows avoiding the dispersion of heat generated, recovering it when required after storage.

Not last and consequent object of the invention is to provide a high-efficiency cell which allows increasing the lifespan of the batteries. A further object of the invention is to provide a cell as defined above in which the ion exchange is carried out optimally.

These and yet other objects are achieved by the high-efficiency, high-temperature, sodium-based electrochemical cell according to the main claim.

### BRIEF DESCRIPTION OF THE DRAWINGS

The construction and functional features of the high-efficiency cell of the present invention shall be better understood from the following detailed description, wherein reference is made to the accompanying drawing tables showing a preferred and non-limiting embodiment thereof, in which:

FIG. 1 schematically shows a longitudinal section of the high-efficiency, high-temperature, sodium-based electrochemical cell of the present invention;

FIG. 2 schematically shows a cross section of the cell in FIG. 1;

FIG. 3 schematically shows a perspective view of the current collector of the high-efficiency cell according to the invention;

FIG. 4 schematically shows a perspective view of the tubular body forming the ceramic electrolyte of the cell.

### DETAILED DESCRIPTION OF THE INVENTION

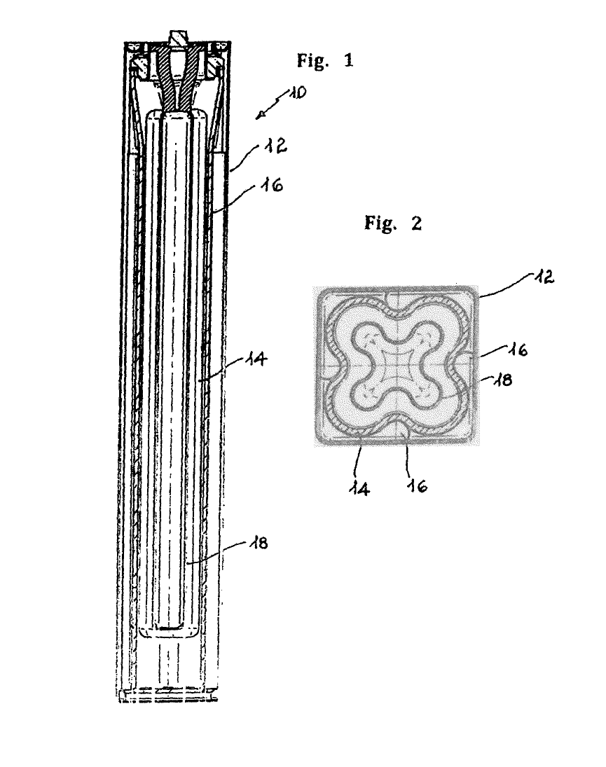

With initial reference to FIGS. 1 and 2, the high-efficiency, high-temperature, sodium-based electrochemical cell for batteries of the present invention, indicated as a whole with reference numeral 10 in FIG. 1, comprises a watertight containment body or outer casing 12, typically elongated parallelepiped in shape, obtained from a steel strip coated with nickel bent and welded. In casing 12 there is inserted a ceramic electrolyte 14 tubular in shape, consisting of β-alumina; according to the exemplary embodiment in FIGS. 1-4, said ceramic electrolyte 14 by way of example defines a four-lobed or cloverleaf section body, in which concave and convex mutually homogeneously alternating develop for most of the longitudinal extension of the body itself. In other known embodiments, the body constituting the ceramic electrolyte 14 defines different configurations, for example having a circular, three-lobed or other cross-section.

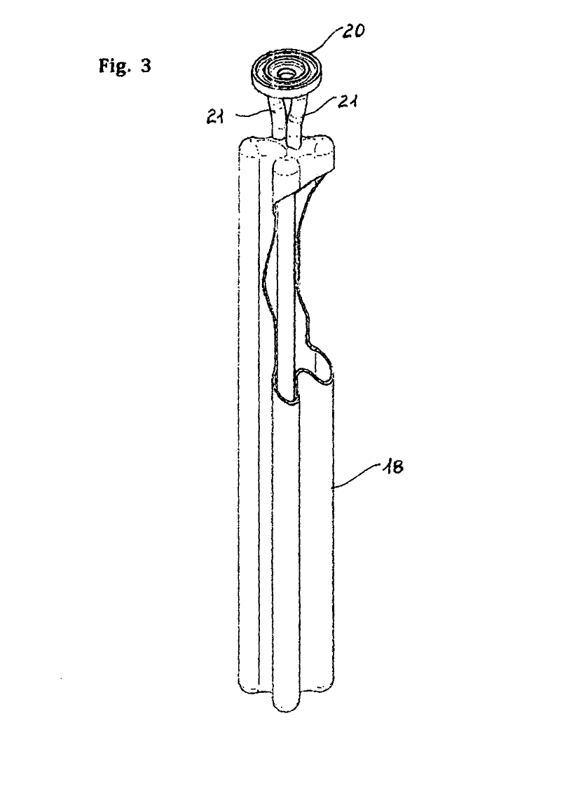

Between casing 12 and the ceramic electrolyte 14 there is arranged a plurality of capillary profiles consisting of shaped sheets 16, which extend by the entire useful ion exchange length and which are shaped in the same way as the lobes of said electrolyte, around which however they leave a gap. In the ceramic tubular electrolyte 14 there is coaxially inserted the current collector, indicated with reference numeral 18 and shown in detail in FIG. 3.

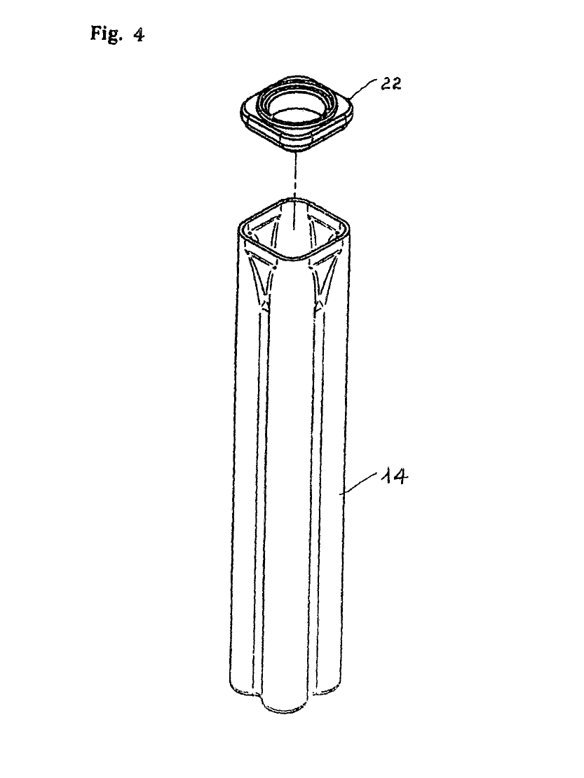

According to the invention, said current collector 18 consists of a hollow body made of metal material such as nickel or alloys thereof, or any suitable metal coated with nickel, which defines an inner volume of roughly a few tens of cm<3>. At least part of such a cavity is filled with materials of the PCM (Phase Change Materials) type, able to exploit a phase transition in the working range of the battery to absorb the heat generated during the discharge. The PCM material is selected according to parameters such as the phase temperature and the fusion enthalpy without neglecting the cost of the raw material. Preferably, said material consists of one or more compounds selected from halides, sulfides, sulfates, nitrates, nitrites, carbonates, acetates, acetyl, thiocyanates, hydroxides, metals and metal alloys with a phase transition in the temperature range between 250° C. and 350° C. Such a material fills the cavity formed within collector 18 by an amount indicatively comprised between ⅔ and 9/10 of the available space starting from the bottom of the collector itself. The presence of the phase transition material directly into each of cells 10, in particular within collector 18 of the cells themselves, in addition to preventing dangerous rises in temperature and also allowing the recovery of the heat stored, has as a consequence the maximum uniformity of temperature between the various cells since the temperature pattern of each cell is regulated by the accumulation/release of heat of the PCM material locally present. According to a further advantageous feature of the invention, the configuration of the current collector 18 is such that the distance in any point thereof from the tubular ceramic electrolyte 14 is constant, so that the ion exchange is carried out in such a way as to optimize the efficiency of cell 10. In order to achieve this result, starting from the hypothesis that the ceramic electrolyte 14 has the four-lobed shape referred to in FIGS. 1 and 2, also the current collector 18 according to the invention defines a similar lateral surface, with a lower section and of the same shape. In the practice, as clearly shown in FIG. 2, the two components 14 and 18, i.e. the ceramic electrolyte and the current collector, repeat the same shape with dimensionally different sections. The current collector 18 is inserted centrally in the ceramic electrolyte 14; in such a position, said collector is stabilised in a known manner, for example by means of welded rod terminals 21 to its upper projecting part, schematised with reference numeral 20 in FIG. 3, in turn welded with the part of the cover of cell 10, indicated with reference numeral 22 in FIG. 4. Since the overall surface of the current collector 18 follows or constantly repeats that of the ceramic electrolyte, considering also the concentricity of said two elements, the distance between them, indicatively comprised between 3.0 and 6.0 mm remains constant in every point; in these conditions, therefore, the ion exchange that occurs through the surface of the ceramic electrolyte 14 of beta-alumina occurs in a constantly uniform manner.

The ceramic electrolyte 14 of each cell 10 and the current collector 18 are typically spaced apart in every point by an extent which may be between 10% and 30% of the maximum transverse dimension of the cell itself. We should consider the hypothesis that cell 10 includes a ceramic electrolyte 14 of a shape other than that four-lobed one indicated above; in fact, the shape of said electrolyte may be three-lobed, five-lobed or have a surface consisting of convex areas alternating with concave areas of any development, either regular or irregular. In these cases, the shape of the current collector 18 will in any case follow that of the body in which it is inserted, i.e. that of the ceramic electrolyte 14, so to keep their mutual distance as constant as possible in each point. As can be noticed from the above, the advantages achieved by the invention are clear.

In the high-efficiency, high-temperature, sodium-based electrochemical cell of the present invention, the substantial thermal uniformity of the cell pack, obtained thanks to the PCM material arranged inside the current collector 18 of each cell, substantially contributes to ensure both the good operation and the lifespan of the battery. Further advantageous is the fact of providing a current collector 18 which repeats the shape, in reduced section, of the ceramic electrolyte 14, to keep the mutual distance between said components as constant as possible in every point and thus optimize the ion exchange.

Although the invention has been described hereinbefore with particular reference to an embodiment thereof made by way of a non-limiting example, several changes and variations shall clearly appear to a man skilled in the art in the light of the above description. The present invention therefore includes all the changes and versions that fall within the spirit and scope of the following claims.

1. A high-efficiency, high-temperature, sodium-based electrochemical cell (10), comprising
an outer casing made of metal material (12), elongated parallelepiped in shape, a ceramic electrolyte (14) in the shape of a tubular body made of β-alumina inserted in said outer casing, and a current collector (18) of metal material coaxially inserted and stabilised in the ceramic electrolyte (14), characterised in that said current collector is formed by a tubular body defining a cavity at least partially filled with PCM (phase change materials) material.

2. The high-efficiency cell according to claim 1, characterised in that said current collector (18) is made of nickel or its alloys or any suitable material coated with nickel.

3. The high-efficiency according to claim 1, characterised in that said PCM material consists of one or more compounds selected from halides, sulfides, sulfates, nitrates, nitrites, carbonates, acetates, acetyls, hydroxides, metals and metal alloys with a phase transition in the temperature range between 250° C. and 350° C.

4. The high-efficiency according to claim 1, characterised in that said PCM material fills said cavity formed inside the current collector (18) by an extent comprised between ⅔ and 9/10 of the available space starting from the bottom of the collector itself.

5. The high-efficiency according to claim 1, characterized in that the current collector (18) inserted in the ceramic electrolyte (14) repeats in reduced section the shape of the electrolyte itself.

6. The high-efficiency according to claim 4, characterised in that the tubular body of β-alumina forming the ceramic electrolyte (14) defines a four-lobed shape.

7. The high-efficiency according to claim 4, characterised in that the current collector (18) and the ceramic electrolyte (14) of each cell (10) are spaced apart at every point by a variable extent between 10% and 30% of the maximum transverse dimension of the cell.
